(19) United States
(12) Patent Application Publication
(10) Pub. No.: US 2014/0328472 A1
(43) Pub. Date: Nov. 6, 2014

(54) System for Managing Spontaneous Vocal Communication

(71) Applicant: HARQEN, LLC, Milwaukee, WI (US)

(72) Inventors: Jeff Fitzsimmons, Fox Pint, WI (US); Pehr Anderson, Wauwatosa, WI (US); Matt Stockton, Milwaukee, WI (US); Kris Gosser, Milwaukee, WI (US); Kevin Lindbergh, Shorewood, WI (US)

(73) Assignee: HarQen, LLC, Milwaukee, WI (US)

(21) Appl. No.: 13/887,616

(22) Filed: May 6, 2013

(51) Int. Cl. H04M 3/42; H04L 29/06

(52) U.S. Cl. CPC H04M 3/42221; H04L 65/403
USPC 379/85

(57) ABSTRACT

A computer system providing access to both the Internet and the publicly switched telephone network allows providing an additional dimension of information capture for oral examinations, dating services, oral histories and storytelling.

### CROSS REFERENCE TO RELATED APPLICATION

Not Applicable.

### BACKGROUND OF THE INVENTION

The present invention relates to communication systems, such as telephonic communications systems, and in particular to a system and method for managing and preserving spontaneous qualities of spoken communication.

The information transmitted in spoken communication goes far beyond what can be captured in a text transcription. The tone or the timing of the speaker can reveal information about the speaker's state of mind, for example uncertainty or self-confidence, as well as nuances related to the information being conveyed (e.g. sarcasm). A speaker's voice may also provide a form of authentication both of the speaker and the integrity of any audio recording. The spoken voice also has subtle dimensions that are attractive, reassuring, or bonding.

The spoken word can be a casualty of improved avenues of communication using computerized and Internet text transmission and spoken words are often segregated from other forms of communication into a distinct, cumbersome and evanescent voice domain. The marginalization of voice communication is partially attributable to scarcity of recording hardware and software on typical computer devices and the difficulties of storing, transmitting, indexing, and retrieving substantial amounts of audio data. Significantly, the real-time qualities of spontaneous verbal communication are often antagonistic to the disjoint qualities of text communications that allow schedule-friendly communication through e-mails or text messages convenient to the communicating individuals.

### SUMMARY OF THE INVENTION

The present invention provides a system yielding improved management of spontaneous spoken communication and integration of such communication into schedule-friendly forms familiar to those using text communication tools. In some embodiments, the invention provides a method of capturing the important dimensions of spontaneous verbal communication in a manner compatible with different schedules of the participants, for example, allowing oral academic examinations and even introductory communications between dating couples to be conducted in a time-disjoint fashion. In this sense, conversations can be or become asynchronous.

In one embodiment of the invention, the invention provides a system for conducting academic oral examinations using an electronic computer communicating electronically with a public switched telephone network and with the Internet and executing a stored program to:

(a) receive an identifier of at least one oral examination candidate;

(b) receive a set of oral examination questions from an academic agent;

(c) within a predetermined time period, establish telephonic communication with the oral examination candidate and communicate the set of oral examination questions as audio signals over a telephone device to the candidate while recording answers to those questions; and

(d) provide access to the recorded answers identified to the questions and to the oral examination candidate over the Internet to the academic agent.

It is thus a feature of at least one embodiment of the invention to provide for an extremely efficient administration of oral examinations to multiple students providing flexible scheduling and simplified grading and evaluation of the examination answers.

The system may provide access over at least one of the telephone system and the Internet to the questions and answers by the oral examination candidate.

It is thus a feature of at least one embodiment of the invention to provide a system that provides oral examination feedback to the student and works with standard telephony or computer equipment likely to be possessed by students.

The access by the oral examination candidate may include a recorded answer to at least one question from another oral examination candidate judged to be a best answer. In this regard, the system may receive input over the Internet from the academic agent identifying a recorded answer for each question from another oral examination candidate judged to be a best answer.

It is thus a feature of at least one embodiment of the invention to provide useful feedback to students in taking oral examinations by allowing them to hear answers judged to be good.

The system may receive over the Internet an input from the academic agent for grading the answers.

It is thus a feature of at least one embodiment of the invention to permit grading of the oral examination in a persistent form at a time other than the taking of the oral examination.

The system may further provide access over the Internet to a history of grades of the oral examination candidate for previous oral examinations.

It is thus a feature of at least one embodiment of the invention to provide improved comparison of responses in oral examinations less prejudiced by the order and time that the oral examination is conducted.

The system may provide access over the Internet to the academic agent of statistics of other oral examination candidates receiving the oral examination questions.

It is thus a feature of at least one embodiment of the invention to provide improved context to a grader of an oral examination.

The system may receive input from the academic agent over the Internet of comments on the recorded answers to be stored and linked to those recorded answers. The comments may be either written comments or recorded comments.

It is thus a feature of at least one embodiment of the invention to permit feedback to the user entirely over a telephone system if desired.

The system may execute the stored program to send an e-mail to the oral examination candidate indicating the predetermined time period for conducting the oral examination.

It is thus a feature of at least one embodiment of the invention to automatically coordinate varied schedules of multiple individuals for an oral examination.

The system may further execute the stored program to accept a telephone number identified to the oral examination candidate and wherein the telephonic conversation is established by an electronic computer calling the oral examination candidate on the telephone number.

It is thus a feature of at least one embodiment of the invention to provide a “call-out” system that does not rely on the students remembering to make a call and the proper call number or examination identification. It is another feature of at least one embodiment of the invention to provide a self-authenticating identification of the students according to telephone number. It is a feature of at least one embodiment of the invention to provide a system that may randomize outgoing calls to minimize risks of collaboration.

The system may randomly select among oral examination questions to be communicated to the oral examination candidate during the telephonic communication.

It is thus a feature of at least one embodiment of the invention to reduce the possibility of improper collaboration on an oral examination that may not be directly witnessed.

The system may forward at least a subset of the oral examination questions and recorded responses to a second academic agent for review.

It is thus a feature of at least one embodiment of the invention to allow multiple stages of review of oral examination responses in their persistent form not generally possible with conventional oral examinations.

The system may provide a grade to the oral examination candidate being a combination of grades by the academic agent and the second academic agent.

It is thus a feature of at least one embodiment of the invention to provide a simple mechanism for reducing grading bias.

In another embodiment of the present invention the above described system may:

(a) record from a questioner at least one question identified to a responder;

(b) contact an identified responder to indicate pending questions and receive a response;

(c) establish a telephone connection to the responder based on the response, the telephone connection recording the responder's answers to the questions; and

(d) present the answers to the questioner by an audio playback mechanism.

It is thus a feature of at least one embodiment of the invention to provide computer moderated conversations between individuals producing a heightened level of anonymity while allowing a constrained communication that captures vocal nuances while allowing flexible scheduling by each participant.

The questions may be provided to the responder contemporaneous with the recording of the responder's answers.

It is thus a feature of at least one embodiment of the invention to capture spontaneous and unrehearsed answers to questions in a manner similar to a face-to-face conversation.

The questions may be provided by an audio message over the telephone.

It is thus a feature of at least one embodiment of the invention to provide a system working with commonly available communication devices that are familiar and nonthreatening for the users.

The system may contact the responder via at least one of a telephone call, and e-mail, or a text message.

It is thus a feature of at least one embodiment of the invention to provide a system that may readily access individuals in a variety of different environments.

The system may provide for a transmission of a message from the responder to the questioner indicating an interest in communication and providing identification so that the computer or an intelligent device comparable to a computer may anonymously contact the responder with questions.

It is thus a feature of at least one embodiment of the invention to permit the questions to be formulated in response to an initial indication of interest by the responding party.

The computer or comparable device may further provide a social networking engine allowing semi-anonymous identification of individuals according to information on the social networking engine and wherein the social networking engine presents webpages allowing indication of an interest in communication to be communicated between individuals using the social networking engine on a semi-anonymous basis.

It is thus a feature of at least one embodiment of the invention to allow for the subtleties of voice communication within the confines of a social networking site preserving some degree of anonymity between participants.

The system may provide the questioner with example questions.

It is thus a feature of at least one embodiment of the invention to promote conversations between individuals that will be both enjoyable and informative.

The playback mechanism may be an audio widget presented on a webpage.

It is thus a feature of at least one embodiment of the invention to permit review of the responses multiple times by the questioner.

In yet a further embodiment, the invention may provide a genealogical website system implemented using this electronic computer to:

(a) receive over the Internet information related to genealogical relationships between individuals having a permission set for the addition of genealogical information;

(b) establish telephonically enabled or assisted communication with a first individual within the permission set to receive a spoken story related to at least one individual;

(c) receive over the Internet from the first individual within the permission set an identification of the spoken story to the second individual; and

(d) provide a display via the Internet indicating the genealogical relationships between individuals having display features indicating spoken stories about the second individual accessible by commands via the Internet.

It is thus a feature of at least one embodiment of the invention to provide a simple mechanism for preserving and indexing short oral histories by individuals.

The display may be a genealogical tree display.

It is thus a feature of at least one embodiment of the invention to provide an indexing system compatible with genealogical data.

The first individual within the permission set may be within the genealogical relationship between individuals wherein the spoken story may relate to the second individual within the permission set.

It is thus a feature of at least one embodiment of the invention to provide a natural proxy system for permissions using genealogical data contained in the system.

The spoken story may also be identified to the first individual.

It is thus a feature of at least one embodiment of the invention to identify all of the oral histories told by an individual such as may also provide an oral history

The system may permit identification of multiple individuals to whom the spoken story relates.

It is thus a feature of at least one embodiment of the invention to permit oral histories that may be shared among multiple genealogical perspectives, that is, can be used for different family trees having a common individual . . . .

The system may allow other individuals within the permission set to make additional modifications of the spoken story.

It is thus a feature of at least one embodiment of the invention to provide collaborative annotation and indexing of oral histories.

In yet another embodiment, the system may provide a storytelling website system operating to:

(a) receive from a storyteller an identification of a story to be told as selected from a set of stories held in the non-transitive media in text files;

(b) record the storyteller's voice reading the text file of the selected story synchronized to the text file;

(c) receive from a listener identification of the story to be told as selected from a set of stories having recorded storyteller voices; and

(d) in response to the identification from the listener, play the recording of the identified story teller's voice.

It is thus a feature of at least one embodiment of the invention to permit an individual, such as a parent on a business trip, to record a story for their child in a time shifted manner.

The recording of the story may be over a telephone.

It is thus a feature of at least one embodiment of the invention to permit the recording to be done without access to sophisticated computer hardware.

The storytelling website system may present a webpage displaying text of the selected story synchronized to a playing back of the recording

It is thus a feature of at least one embodiment of the invention to permit the child to follow along with the story in a manner roughly approximating a personal storyteller.

Another embodiment of the invention may provide for a pharmacy call answering system in which the electronic computer executes the stored program to:

(a) receive telephonic communications from individuals seeking prescriptions and using telephones associated with the individuals;

(b) provide a set of recorded questions to the individuals separated by periods during which the individuals may respond;

(c) record individual responses in the periods of separation;

(d) provide access to the recorded responses associated with the questions over the Internet for transcription of the recorded responses and linkage of the responses to a patient file; and

(e) enroll a prescription request associated with the telephonic communication in a work queue accessible by pharmacy workers over a computer terminal.

It is thus a feature of at least one embodiment of the invention to provide a structured framework for spontaneous verbal communications such as are received over a telephone answering system.

The questions may be selected from the group consisting of: a name of a referring physician, a patient name, and a medical insurance identification.

It is thus a feature of at least one embodiment of the invention to ensure pharmacy users provide necessary information to ensure fulfillment of their order.

The pharmacy call answering system may provide a lookup table of existing patient names for matching to the patient name. Alternatively or in addition the pharmacy call answering system may provide proposed transcriptions based on the patient name from the table of patient data.

It is thus a feature of at least one embodiment of the invention to simplify a conversion of vocal communication into indexable machine-navigable information.

The prescription request may be further enrolled within a file associated with the patient.

It is thus a feature of at least one embodiment of the invention to provide a system that integrates with patient records systems and order fulfillment systems to provide efficient management of call in orders.

The patient name may be pre-populated based on a telephone number of the patient.

It is thus a feature of at least one embodiment of the invention to make use of the telephonic medium to provide authentication of the caller.

These particular features and advantages may apply to only some embodiments falling within the claims and thus do not define the scope of the invention.

### BRIEF DESCRIPTION OF THE DRAWINGS

FIG. 1 is a block diagram of hardware elements employing typical embodiments of the invention providing a central server communicating with remote users both via a standard telephone network and Internet connected remote computers;

FIG. 2 is a data flow diagram showing steps and data flows implementing an oral examination of students using the system of FIG. 1;

FIG. 3 is a sample interface presented to a test creator allowing review of spoken answers to questions;

FIG. 4 is a second sample interface presented to a test creator allowing comparison of multiple answers received at different times;

FIG. 5 is a data flow diagram showing data flows in allowing multiple graders to review answers of an oral examination;

FIG. 6 is a sample interface presented to a test taker providing feedback on their test results;

FIG. 7 is a data flow diagram of a second embodiment of the invention employing the system of FIG. 1 in providing voice communication in a dating service;

FIG. 8 is a flowchart showing steps executed by the program, as distributed between multiple computers, associated with a questioner and a responder implementing the data flow of FIG. 6;

FIG. 9 is a screen display provided to a questioner providing sample questions he or she might ask;

FIG. 10 is a screen display optionally provided to a responder giving him or her advance notice of the questions;

FIG. 11 is a sample interface provided to the questioner for allowing review of the answers as spontaneous vocal responses;

FIG. 12 is a data flow diagram and screenshot showing the association of oral histories with a displayed genealogical chart;

FIG. 13 is a flowchart showing the steps implemented by a program on the system of FIG. 1 in receiving oral histories and identifying them to individuals in the genealogical chart;

FIG. 14 is a database logically representing an underlying data structure for the program of FIG. 12;

FIG. 15 is a data flow diagram of the system of FIG. 1 in an alternative embodiment employing the system of FIG. 1 for recording of written stories in audio form, for example, by caregivers for their children;

FIG. 16 is a screenshot of a dynamically generated webpage for playing back the recorded story together with synchronized text display;

FIG. 17 is a sample interface presented by the system of FIG. 1 and a data flow diagram for yet another embodiment allowing entry of a series of standard questions for users of the pharmacy answering machine; and

FIG. 18 is a sample interface and a data flow diagram showing processing of the recorded answers by an individual leaving a message on the answering machine as integrating to a patient records system.

### DETAILED DESCRIPTION OF THE PREFERRED EMBODIMENT

### Hardware

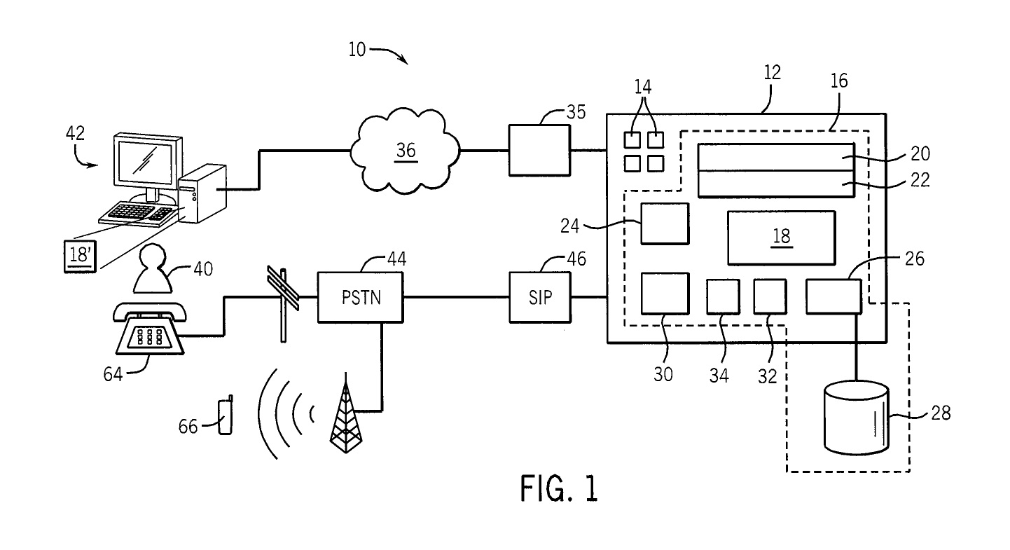

Referring now to FIG. 1, a combination telephone/internet server 10 of the present invention may include a computer server 12 having multiple processors 14 communicating with a memory system 16 (including generally random access memory, disk storage, as well as online storage and cloud services).

The memory system 16 may hold a variety of executable programs including an operating system 20, for example, Ubuntu Linux, available and described at http://www.ubuntu.com/ and a virtualizer 22 such as Kernel-based Virtual Machine (KVM) available and described at http://www.linux-kvm.org to create multiple virtual machines (for example each handling a separate conference call) as is generally understood in the art. Each of the virtual machines may execute additional programs held in memory system 16 including server software 24 such as the Apache server available and described at http://www.apache.org providing standard web and other server functionality, and a database program 26 such as PostgreSQL available and described at http://www.postgresql.org communicating with a database record 28 and providing indexable and searchable data structures. A telephone system interface 30 such as FreeSwitch available and described at http://www.freeswitch.org may provide for a telephony platform allowing the routing of audio text and other media. Although the invention is described with reference to certain open source software components, this is not a requirement for its operability and those skilled in the art can, aided by the description herein, select suitable alternatives for some or all of the identified programs.

As is generally understood in the art, server software provides communication over the Internet with multiple browser programs and may serve applications and data from the combination telephone/internet server 10. The database program 26 may manage data to be readily searched and updated typically by storage of a structure of records having fields. The telephone system interface 30 provides an interface between the computer server 12 and a standard telephone network.

The memory system 16 may further hold a special application program 32 (for example an academic grading program such as blackboard, a pharmacy record-keeping system providing a method of storing and retrieving customer contact information, a genealogy program, or a social networking engine). Finally, the memory system 16 may run an e-mail program 34 for sending and receiving e-mail such as the Outlook program also from the Microsoft Corporation described above.

The computer server 12 may communicate through standard electrical interfaces (e.g. Ethernet cards) with a firewall 35, for example, a high-availability firewall available from Fortigate, Inc. (http://www.fortinet.com). The firewall 35 may be connected through the Internet 36 with remote users 40 via remote terminals 42 associated with each of the users 40.

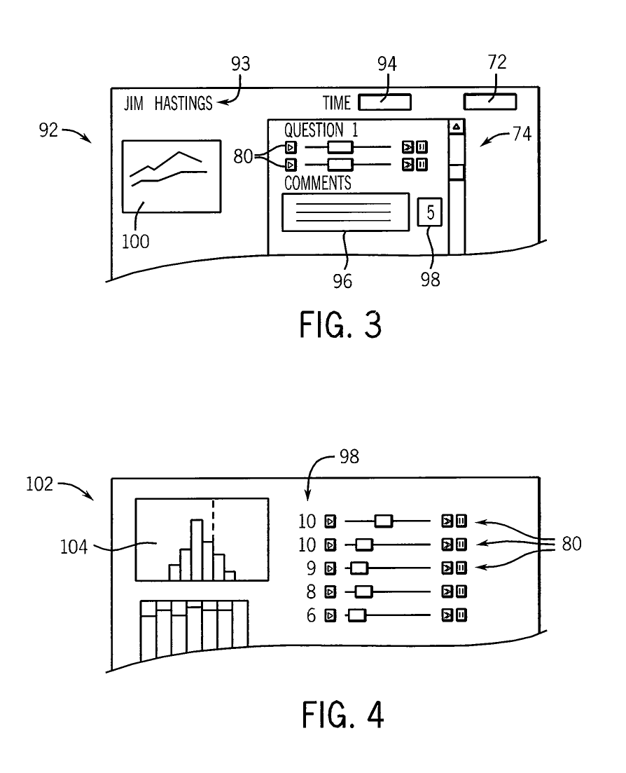

Referring momentarily to FIG. 3, generally each terminal 42 may be a standard desktop personal computer including a processor system 48 holding one or more processors 50 communicating with a memory 52. Memory 52 may hold, for example, a standard operating system 54 such as the Microsoft Windows operating system from the Microsoft Corporation referenced above. The memory 52 may also hold a browser 56 such as the Firefox browser available from and described at http://www.mozilla.org and further may hold possibly a portion of the program 18′ of the present invention preloaded or downloaded from the computer server 12. The processor system 48 may communicate with a graphics terminal 55, a keyboard/mouse 57, an Internet connection 58, a microphone 60 and/or a web camera 62, all generally understood in the art.

Referring again to FIG. 1, the computer server 12 may also communicate with the public switched telephone network (PSTN) 44 via a SIP Trunking system 46, provided by one of multiple commercial suppliers as is generally understood to those of ordinary skill in this art. The PSTN 44 may communicate with a given user 40 via a standard landline telephone 64 or a cellular telephone 66 accessible to the user 40 when operating the terminal 42.

### Software and Operation

### I. Academic Oral Examination System

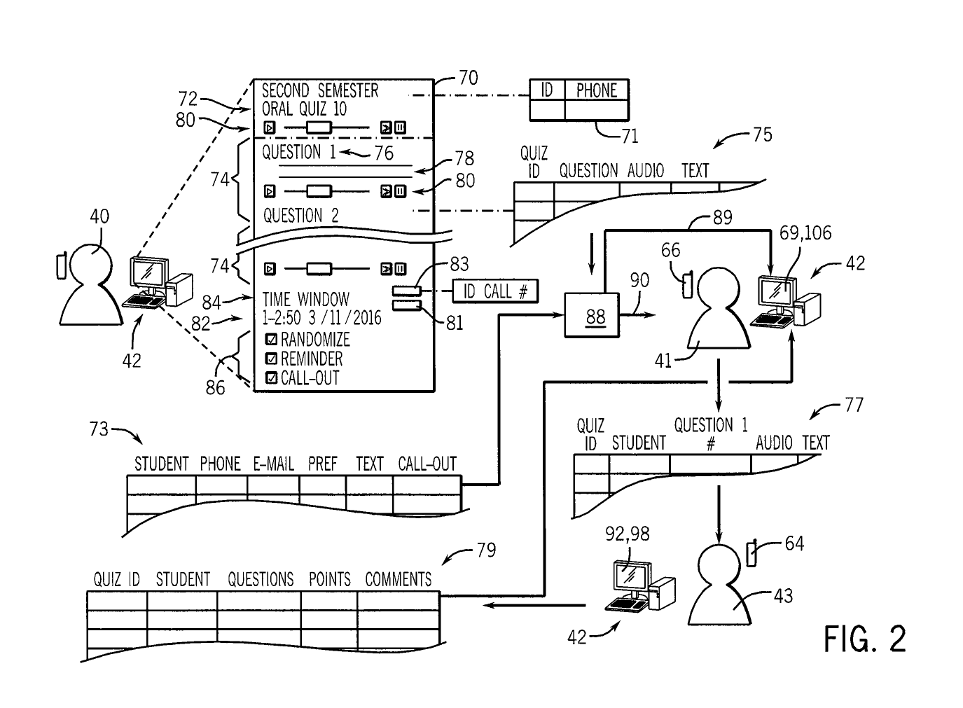

Referring now to FIG. 2, a schedule-flexible, academic oral examination may be created by a user 40 such as professor serving as an academic agent and using terminal 42 executing program 18. Generally, the oral examination implemented by the program 18 works with multiple data files including an agent data file 71 holding information about the user 40 generating the examination, a student database 73 holding information about the students who will be taking the examination, the examination database 75 holding the particulars of the oral examination, the answers data structure 77 holding the student responses, and a grade file 79 holding evaluation of the student answers related to the examination. Each of these structures will be described below in a normal testing sequence; it will be generally understood that they may be in separate relational database files, a logically single flat file, or other structure as dictated by programming efficiencies. The illustrated fields and records are intended to be nonlimiting examples.

An academic oral examination may be set up via a display screen 70 generated by the program 18 providing for the entry of examination identification information 72, for example an examination name or number and a date. This identification information 72 may link to a key field in an academic database, such as Blackboard (commercially available from Blackboard, Inc. of Washington, D.C.), to connect the information associated with the examination to an academic record-keeping system for holding grades and the like.

This examination identification information 72 will be entered into an examination database 75 to provide an index field for records of the examination, the latter of which will generally include examination questions (represented audio and text fields). Provision may be made for the entry of an audio description of this examination identification information 72 that may serve as an introduction to student user 41 taking the oral examination solely through a telephone 64 without a display.

The content of the examination may then be entered via the display screen 70 to be stored in the examination database 75. In one embodiment, the creator user 40 may enter a series of questions for the examination in question fields 74 each indicating a sequential question number 76 and allowing for the entry of optional text transcription of the question 78. The question itself will in the form of an audio file (stored as a record in the examination database 75) manipulated using a recording audio widget 80 the type well known in the art allowing for the recording and playback underlying audio data. The text transcription of the question 78 of each question field 74 may be entered through the keyboard associated with the terminal 42 which may also be used to navigate between question fields 74.

An arbitrary number of question fields 74 may be completed as will be described below.

Upon completion of the question fields 74 for the examination, the creator user 40 may be presented with an examination logistics field 82 allowing the creator user 40 to enter information about a time window 84, being a period of time allotted for taking of the examination, for example expressed as a starting and ending time defining a period of time during which the examination may be taken. In addition, the creator user 40 may select among a set of options 86 defining particular characteristics of the oral examination. One option allows a larger set of examination fields 74 to be completed but only a subset of these examination fields 74 to be used for the examination of any given individual, with the particular questions from the question fields 74 being selected randomly. This option accommodates concerns about improper collaboration by student users 41 possible with a remote examination process. Invoking the randomization option may open a window (not shown) in which the creator user 40 may define the total number of questions of the examination and may select among different questions as being either among the randomly selected questions or among a core set of questions that are always available in each examination. In one option, some questions may be identified as correlates, for example, being different phrasings of questions about the same concept so that in the randomization process one among the correlates must be selected.

A reminder option may also be selected which provides an e-mail reminder to the student users 41 about the oral examination and its time window. This reminder e-mail may also include a call in number and examination identification number allowing the student users 41 to call in on their telephones 64 or 66 to connect with the particular examination on the server 12.

A third option may be a call out option in which the server 12 calls out to the student users 41 to initiate the examination eliminating the need for the student users 41 to call in to take the examination and to memorize or store the call in number and test identification number.

The audio data entered through the audio widget 80 may be captured using a microphone associated with terminal 42 or may be via a standard telephone 64 or 66 of the student user 41. In one example, the recording of the audio is implemented by a callback system in which the telephone number (N identification) of the creator user 40 previously entered into an agent data file 71 is used by the program 18 to trigger a call through the server 12 and the PSTN 44 to the creator user 40 allowing the creator user 40 to make the necessary recording of the questions speaking through standard telephone equipment. The callback may be initiated by pressing of a callback button 81 on the screen 70.

In this embodiment, the creator user 40 may be given a series of audio prompts for each question through the telephone 64 or 66. In one implementation, a synthesized audio voice may indicate a question number or may read the text entered for the question. A cue tone may then be provided for recording of the question. It will be understood that this process may also be completed solely with a standard telephone 64 or 66 using audio prompts and the dialing buttons for review and editing of the question according to techniques well known in the art of voicemail retrieval and recording.

Alternatively, a call in number and examination identification may be automatically generated and provided to the creator user 40 by the program 18 as initiated by the creator user 40 pressing a call in button 83. In this case, the creator user 40 may then use her telephone 64 or 66 to call in to the call in number and by providing the proper identification (or automatic identification of a registered telephone number) may be connected to the program 18 for recording questions with the same audio prompts system described above.

In yet an alternative embodiment, a microphone associated with the terminal 42 may be used for the entry of the data through the audio widget 80. These different techniques will apply to all of the embodiments described in this application.

Upon completion of this process of recording the examination questions, the creator user 40 may review the audio-recorded information using the widgets 80 (or telephone dialing button controls) to satisfy himself or herself of the accuracy and clarity of the questions and their correspondence to the question 78 of the text field.

As noted, the information provided through the screen 70 is collected in the examination database 75 which may be read by an examination engine 88 implemented by the program 18 which serves to implement the examination at the appropriate time. The examination engine 88 monitors the entered information about time window 84 and at a predetermined time before the time window 84, or the time dictated by the creator user 40, sends an e-mail or text message notifying the student users 41 of the examination. This notification may be sent, as indicated by arrow 89, to e-mail or text message receiving devices, for example, terminals 42 or cell telephone 66 associated with student users 41. This e-mail may contain reminder information about the examination (and optionally a call in number and examination identification number) as well as links to study aids, practice examinations, and the scope of tested subject matter as may be desired. The e-mail, for example, may also include contact information for the professor in the event of scheduling problems and may confirm telephone numbers and the procedure under which the examination will take place.

When the examination engine 88 determines that the time window 84 has arrived, telephonic communication 90 with each of the student users 41 is initiated. The contacts with the students through telephonic communication 90 may be done simultaneously to eliminate problems with information about the examination being disseminated or may be done randomly by groups or individuals during the time window 84. As noted above, the process may be implemented either by call-ins by the student users 41 during the time window 84 or by an automatic callout procedure by the latter which may better enforce the timing and ordering of the oral examinations.

In one embodiment, the oral examination may be conducted entirely via the PSTN 44 with identification information 72 being provided either by a speech engine working off the text-entered identification information 72 or as recorded by the creator user 40. Each question as recorded by the creator user 40 is then read and a cue tone provided for the response by the student user 41. In one embodiment, the student's first exposure to the question is during this telephone call and thus the student's familiarity with the material, manifest in an ability to make a spontaneous reply, is fully captured in the manner of the conventional oral examination thus preserving these features of a regular oral examination. This approach may be contrasted to a text or open book examination and yet, like these latter examination techniques, the oral examination process may be implemented using this system in a highly efficient and semiautomatic fashion. To emphasize the significance of spontaneity, the examination parameters may include a time window that sets a cutoff for the student response.

One alternate embodiment of this invention may provide the student user 41 with the ability to view a screen 69 (similar to screen 70) on terminal 42, for example, to provide for a written version of the questions as may be required, for some student users 41 may have difficulty with the audio format. In this example, the student users 41 review text questions but provide audio answers through the PSTN 44.

Optionally, in this embodiment, audio widgets 80 may be presented to allow the student users 41 to review and/or edit their answers within the time window 84. This editing may be provided by communication of data input through the terminals 42, for example, indicating a desire to rewind and replay the answer to rerecord the answer to the server 12 which may then receive the new information over the PSTN 44. Thus this additional functionality does not require that the student users 41 have audio capabilities associated with terminals 42.

It is contemplated that the program 18 may optionally allow some student users 41 (for example, disabled students) to enter information via text fields that may be presented (not shown) on the screen 70.

The information from the student users 41 when in the form of a spoken response or the like is recorded in the answers data structure 77 to be reviewed by a grader user 43 (optionally being the creator user 40). In this regard, it will be appreciated that the replies of the student users 41, as recorded, may be reviewed at the convenience of the grader user 43 and in fact may be reviewed by multiple or different grader users 43 as will be described below.

Referring now to FIG. 3, the grader user 43 may receive the data of the answers data structure 77 presented in a grading screen 92 generated by the server architecture of server 12 operating under program 18. This grading screen 92 may conveniently provide information necessary for the grading process including a student name 93, time of the examination 94, and the examination identification information 72 previously described. Each of the question fields 74 may be reproduced with multiple widgets 80, one for the recorded question and one for the recorded answer. A comment text field 96 may be provided as well as a text entry field for a numeric grade 98. It is contemplated that the program 18 will be able to communicate with academic record systems such as Blackboard obtain 100 related to the previous grades and the like of the student users 41 which may provide context to the grader user 43. Generally, the grading process may be conveniently accomplished through the grading screen 92 with the grader user 43 listening to the student responses and providing comments in the comment text field 96 and a number grade 98 in the grade entry field and moving through the question fields 74 sequentially.

This information from the grading screen 92 populates the grade file 79 which includes identification of the student user 41, the examination identification and, for each question, the points and comments generated by the grader user 43.

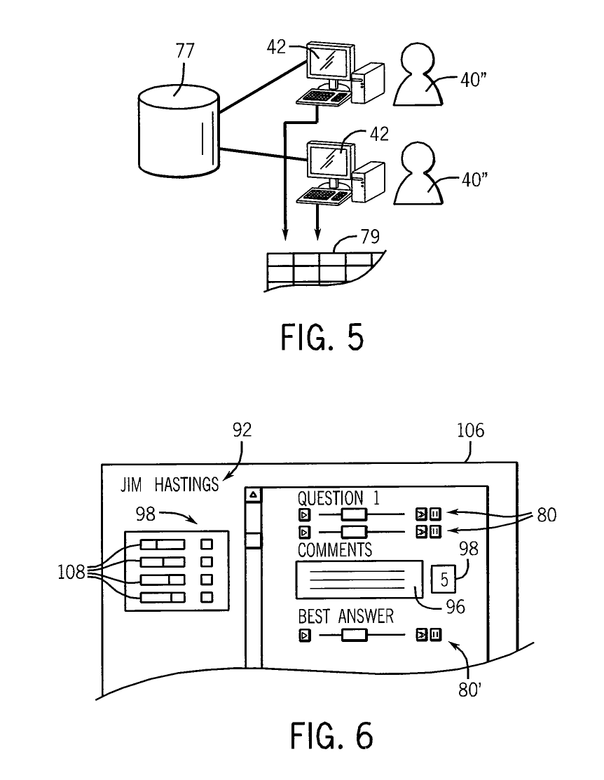

Referring momentarily to FIG. 5, the ability to capture the spontaneous response by the student user 41 can be used to provide better accountability of the grading process of an oral examination. Thus, for example, the answer data structure 77 may be forwarded to multiple grader users 43 associated with different terminals 42 who may grade the same students or review the grades of the students for consistency. In the case where multiple gradings occur, statistical combinations such as averages or the like (with outlier detection and exclusion) may be entered into the grade file 79.

Referring now to FIG. 4, in this review process, any of the grader users 43 may have access to a statistic screen 102, for example, providing for histogram curve 104 of answers to the questions across different students and collecting audio widgets 80 for answers to each question among the different students, for example, as ranked by the grade received. The statistic screen 102 can provide better longitudinal consistency of examination grades by overcoming a problem of natural bias resulting from the sequence of the review of the examination answers that is otherwise difficult to eliminate in an oral examination environment. The grader user 43 may review the answers for all of the students from best to worst to see that the grades originally assigned accurately conform to the global assessment of the answers among the pool of students. At this time, grader user 43 may select a best answer for each question as will be discussed below.

When the grader user 43 is not the professor (the creator user 40) who will post the final grade, the grader user 43 can may attach flags and notes to each the grade file 79 or answer data structure (either as text or audio recordings) to identify portions of the file the professor needs to hear and perhaps with the reason for listening to those segments. Thus, the professor need not listen to every complete audio file but only those flagged by his teaching assistant (grader user 43).

Referring still to FIG. 2 and also to FIG. 6, the grade file 79 for each particular student user 41 may be forwarded to the terminal 42 of that student user 41 to provide him or her with feedback with respect to their performance on the oral examination, including actual recording of the examination performance, something not normally possible with oral examinations. In particular, information of the grade file 79 may be presented in a review screen 106 generated by the server of server 12 under the guidance of program 18, the review screen 106 indicating the student's name 93, grades 98 for each question and how each grade compared to grades from the other students in a simple bar display 108. Importantly, the student user 41 may review the questions and actual recordings of his or her answers through audio widgets 80 for each question in a question field 74. In this way, the student user 41 gains valuable insight into his or her performance in responding orally in a spontaneous environment. Each question will provide the student with the grade 98 and the grader's comment text field 96 and helpfully may provide an audio widget 80′ providing an answer that the grader user 43 considers the best answer so the student may target their achievement to a higher level.

Alternatively, this information may be relayed via the telephone system using telephone dialing buttons as described above.

### II. Audio Dating System

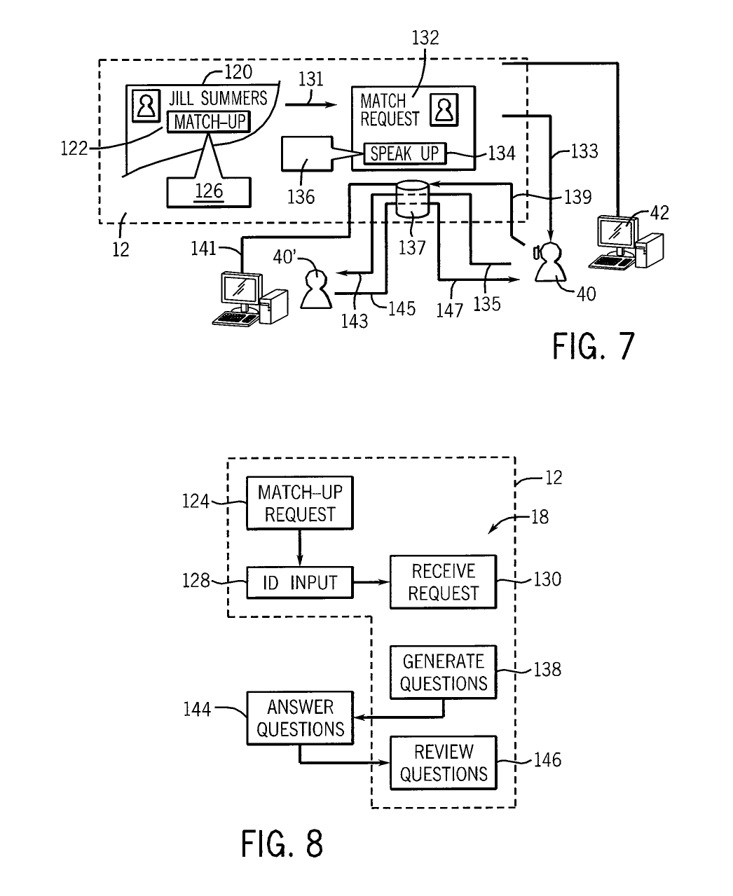

Referring now to FIG. 7, another context where a premium may be placed on capturing spontaneous qualities of vocal communication is with respect to dating. Here, the combination telephone/internet server 10 of the present invention may not only allow for schedule flexibility in spoken communication but may preserve the anonymity of an individual's telephone number and other personal information by shielding the spoken communication within the protective boundaries of the server. These features foster asynchronous and anonymous conversations and thus facilitate broader possible interaction at the users' convenience.

Referring to FIGS. 7 and 8, in this embodiment, program 18 may establish or work with a social network webpage 120 providing some personal information about an individual or may provide a link to or from such a webpage, for example a link on a webpage on Facebook or the like. In this latter case, the webpage may provide for a button 122 for initiating a “match-up request” by an individual viewing the webpage 120. The “match-up request” indicates a desire to communicate with the person whose information is depicted.

For example, “Jack Thomas” (user 40′) may view the webpage 120 of “Jill Summers” (user 40) and request a match-up with her by invoking button 122 per process block 124 of FIG. 8. Activating the button 122 may display a permission and terms window 126, for example using a pop-up window, providing the rules and terms of the service and requesting identification information per process block 128. In the case where “Jack Thomas” is also a subscriber to the common social network, the identification information may be Jack's screen name or other unique identifier. Generally this information need not personally identify Jack.

If Jack Thomas is not a subscriber to the common social network then Jack Thomas may enter a telephone number or e-mail address and some basic information about himself that he is comfortable revealing, for example an identification to a different social networking site. This telephone number and e-mail address will be preserved in confidence from Jill Summers under the terms of the permission and terms 126 through the agency of the program 18. It should be noted that, except for agreeing to the terms of service, making a matchup request may be done simply and spontaneously. For this reason, a given individual may receive multiple concurrent matchup requests.

As indicated by process block 130, Jill Summers then receives the request for a match-up via internal data communication within the program 18 indicated by arrow 131 manifest per a private page 132, for example the common social networking site. This request offers the opportunity for a “speak-up” connection that may be invoked by button 134. If Jill Summers is interested in a speak-up connection, and presses the button 134, a pop-up window 136 or the like may provide for the terms of the service (indicating that Jill Summer's telephone number will remain anonymous) and she is prompted to select or generate several questions for the speak-up connection as indicated by process block 138.

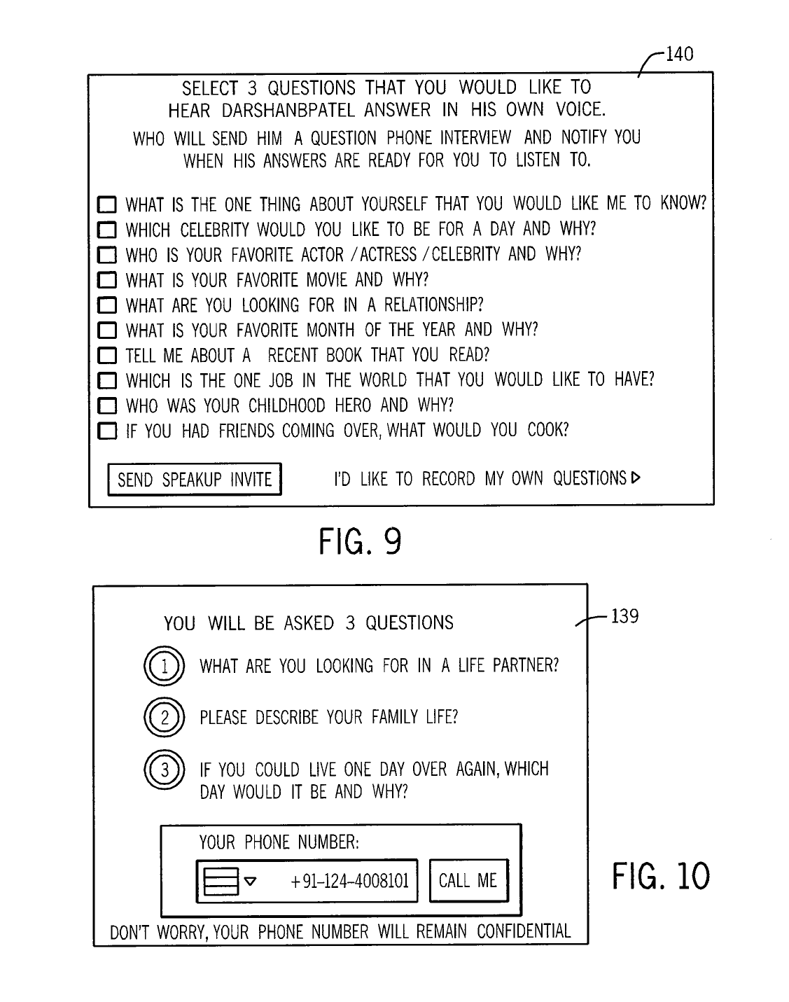

Referring to FIG. 9, in order to facilitate the generation of these questions, a screen 140 may present various question options with checkboxes allowing her to select three pre-prepared questions for example:

What is the one thing about yourself that you would like me to know?

Which celebrity would you like to be for a day and why?

Who is your favorite actor/actress/celebrity and why?

What is your favorite movie and why?

What are you looking for in a relationship?

What is your favorite month of the year and why?

Tell me about a recent book you read.

What is the one job in the world would love to have?

Who was your childhood hero and why?

If you had friends coming over, what would you cook?

These questions are intended to reveal something about the person answering the question and provide an open ended starting point for conversation. Alternatively or in addition, Jill may use previously prepared questions that may have been, for example, submitted in response to previous matchup requests.

Alternatively or in addition, a link is provided for Jill Summers to record one of these questions in her own voice or to prepare her own questions spoken in her own voice. This latter approach permits Jill to revise additional information to Jack Thomas who can hear Jill Summers' actual voice.

In the event that Jill wishes to record her own questions, server 12 may call Jill Summers as user 40 and through a telephone prompting system similar to that described above with respect to the oral examination process (or combination of telephonic and Internet communications) may record multiple questions for Jack Thomas as indicated by arrows 133 and 135 respectively with the recorded questions stored by the program 18 in a databank 137.

The program 18 may then contact Jack Thomas either through the enforced confidentiality of the common social networking site implemented by program 18 or, if Jack Thomas is not a member of the common social networking site, through the e-mail or telephone number that Jack provided with respect to process block 128. This e-mail or telephone number is preserved in confidence from Jill in the internal data structures of the program 18 enforced by the program 18.

Referring also to FIG. 10, in the event that the e-mail route is adopted, Jack Thomas is sent an e-mail indicated by arrow 141 (of FIG. 7) that provides a link to a webpage 139 with the questions he will be asked and a button 142 adjacent to his telephone number requesting that the server 12 call him. Upon invoking this button 142, the server 12 calls Jack and Jack's telephone rings indicated by arrow 143 allowing him to answer it as indicated by arrow 145 and to answer the questions in a manner similar to that described above with respect to the academic oral examination.

Alternatively, in a pure telephonic version, Jack Thomas is provided with a text message or recorded voice message indicating that he has pending questions from Jill. The text message may provide a call-in telephone number and transaction number related to the questions, or allow a text (SMS) response which causes a call to be sent to Jack Thomas for him to answer these questions. In either case, telephonic communication is established between the server 12 and Jack Thomas permitting his voice responses.

In all cases, it will be recognized that, although there is asynchronous vocal communication between Jill Summers and Jack Thomas, at no point do they directly exchange telephone numbers. In this respect the communications are “semi-anonymous” meaning that the actual individuals cannot be identified from the information exchanged (most significantly telephone numbers), but that unique communication may be established between anonymous individuals as linked by confidentially preserved data held in the computer system itself. Nevertheless, the system offers recorded spontaneity in varying degrees. In the pure telephonic version, Jack Thomas's first exposure to the questions may be by a voice playback seconds before he delivers his answer. In the e-mail version, Jack has time to formulate his answers although other vocal clues are captured by the system.

Advantageously, the system allows busy individuals to schedule communication at their convenience without requiring overlapping conversational time.

Referring again to FIG. 7, indicated by process block 146, Jill may then receive the recorded answers for review as indicated by arrow 147 in FIG. 7. At this point, Jill Summers' entire interaction with Jack Thomas has been through the protected environment of the program 18 operating on the server 12 through terminal 42.

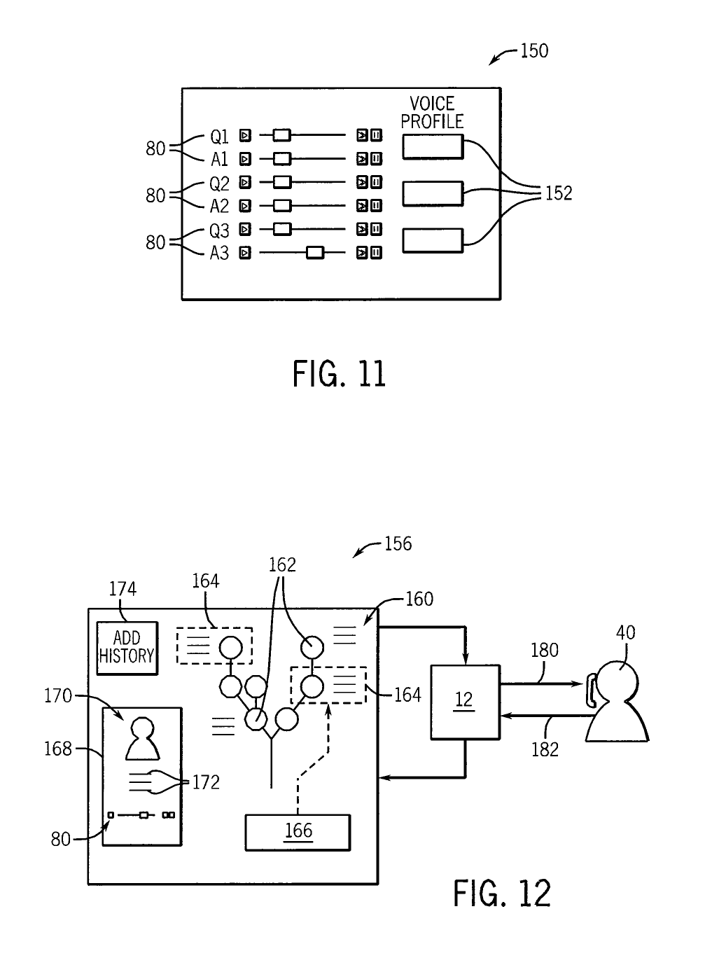

Referring also to FIG. 11, this review process by Jill may be implemented through a screen 150 developed by the server 12 on terminal 42. The implementation of the review process through screen 150 resists forwarding of the Jack's audio responses to others and may limit the amount of time during which they are retained on the system (as opposed to receiving voice information in an e-mail or the like). The limited persistence of these answers, according to the terms presented to each user, may promote more candid and more intimate responses without fear of a breach of privacy expectations. On the other hand, the short term storage of the answers allows Jill to refer to these answers and compare them against other matchup request candidates and may allow her, for example, to annotate the responses.

The screen 150 may provide for separate audio widgets 80 for each question and answer and may optionally provide for voice analytics indicators 152, for example, indicating a level of speaker stress that may be used by the listener to obtain additional insight into the speaker.

As a variant of the dating system described above, persons interested in using such a process to search for others having compatible traits and characteristics may be invited to complete a more thorough questionnaire such as one promulgated and monitored by Values Technology (www.valestech.com). The results from such a “values screening” can then be used as a filter to rule in or rule out certain individuals who match or most closely match the desired traits or characteristics thus managing the pool of those with whom an individual may wish to meet.

Referring again to FIG. 7, in all cases, Jill has a recorded audio file in databank 137 of the program 18 with Jack's answers to her questions, whether from the menu of stock questions or originated by her. When listening to the recording from Jack, Jill can add flags to the audio file recorded in the databank 137 to denote areas of particular interest to her, with or without her own written comments as indicated by arrow 139. Likewise, system software 18 can tag the file with auto-generated flags such as flags to identify and separate individual questions and answers. Assuming Jill has other persons of interest, she can use the system of the present invention to add notes to the audio files of each individual as well as compare and contrast their answers to her questions.

### III. Oral History System

The richness of spoken communication can also be desired in contexts where additional information is not required (e.g. in assessing student performance or a potential partner) but where the nuances of the spoken voice enhances an emotional connection to the individual. One example of this is in the recording of oral histories.

In this respect, recording a speaker's voice operates not only to lower the threshold for the recording process (it being generally simpler to record speech than to enter text in other forms) but also to capture the nuances and subtleties available in recorded speech. Again, integration with the telephone network provides for a natural interface for such vocal recording.

Referring now to FIG. 12, in one embodiment, the server 12 may provide for a genealogy webpage 156, for example, allowing editing users 40 to enter family tree information. This information may be displayed in a tree 160 comprised of nodes 162, for example, comprising individuals in the family tree together with the nodal annotations 164 providing information about the individuals. The nodal annotations 164 may be accompanied by pop-up windows 166 that expand when a cursor hovers over the nodal annotations 164 or in sidebar 168 providing additional information about the person of the node, for example, including a photo 170 and biographical information 172. This allows the nodal annotations 164 to be spatially proximate to the nodes but to be unconstrained by information limitations.

In this embodiment, the biographical information 172 may include audio widgets 80 holding short oral histories related to the individual. The content accessed by these audio widgets 80 may be added by invoking an add oral history button 174 which will result in the addition, ultimately, of an audio widget 80 associated with one of the nodes 162.

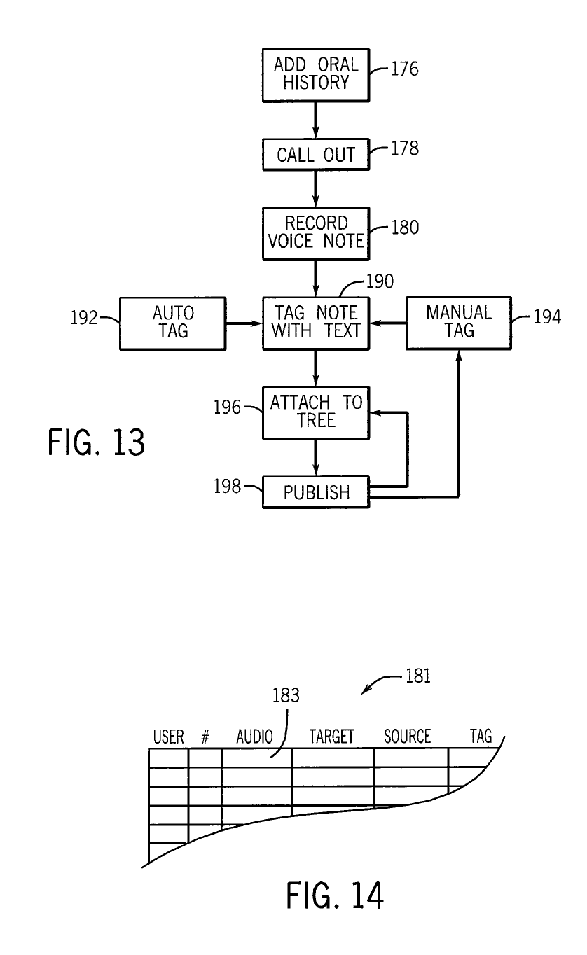

Referring also to FIGS. 13 and 14, upon pressing of the oral history button 174 as indicated by process block 176, the combination telephone/internet server 10 may place a telephone call to a telephone number registered to the user 40 editing the genealogy webpage 156 as indicated by process block 178 and arrow 180 (in FIG. 12) using the server 12 and the mechanism described above with respect to the oral examination and dating systems together with an oral history database 181. The oral history database 181 identifies the editing user 40 in a first field and provides the editing user's telephone number in a second field. A telephone call is then made to the editing user 40 who may record a short audio note 183 stored in a third field of that database record. This recording process is indicated by arrow 182 and process block 184.

As indicated by process block 190, next the audio note may be tagged with text information also stored in the record associated with the audio data 183. This text information may be generated by an auto-tagging process indicated by process block 192, for example, automatically identifying the editing user 40 who is preparing the note and the date and time of the tagging information. Other tagging may occur as indicated by process block 194 by the user 40, for example, through manual entry through a keyboard or the like. Both the auto tagging of process block 192 and the additional tagging of process block 194 may alternatively be in audio form, using the process described above with respect to recording of the short audio note 183.

As indicated by process block 196, the audio note 183 is then linked to a particular node 162 (for example, the node 162 currently having focus) being a “target note”. This linking process generally identifies a person to whom the audio history relates. Alternatively, the audio note 183 may be stored and the user 40 may identify a particular node 162 at a later time. In this way, the particular user 40 may record their recollections of another person in their family tree who is not yet enrolled in the tree 160.

The audio note 183 may further be associated with the node 162 of the user 40 (“source node”) so that individuals reviewing the family tree 160 may also hear all the stories prepared by a particular individual (the editing user 40) about other members of the family recorded in the editing user's own voice. Of course, a particular audio note 183 may be associated with multiple family members to which it refers by the addition of extra target fields in a record.

At process block 198, the audio note 183 may be “published” making the audio widget 80 visible to other users having permission to view the genealogy webpage 156 and allowing their addition of tags per process block 194 or associated nodes 162 per process block 196.

In this way genealogical information may be augmented with spoken oral histories that allow an individual to hear, potentially, ancestors that may have passed away.

This formulation of questions and identification of information for the family tree may be encouraged by displaying a set of canned and typically open-ended questions as part of the manual tagging of process block 194. Selected ones of these questions or questions developed by the user 40 may be incorporated into the tagging process so that other users may be enlisted in collaborative effort in the preparation of the genealogy webpage 156. When a node 162 is tagged with a question per process block 194 and 192 (or verbally by process block 184) the user 40 may be given an option to reach out to another individual, typically within the permission set, who has or may have information related to that question. This process may for example generate an e-mail or automated call to that individual to initiate a process of adding the necessary information through the sequence of process blocks 176-198 described above. This process may be used for general or specific questions, for example, a person doing family research may reach out to someone for a story pertinent to the family history, and in this case the question can be very open ended (e.g., tell us what it was like for the family during WWII). During this process the second individual can also contribute original material not responsive to a particular question to the website 156.

### IV. Storytelling System

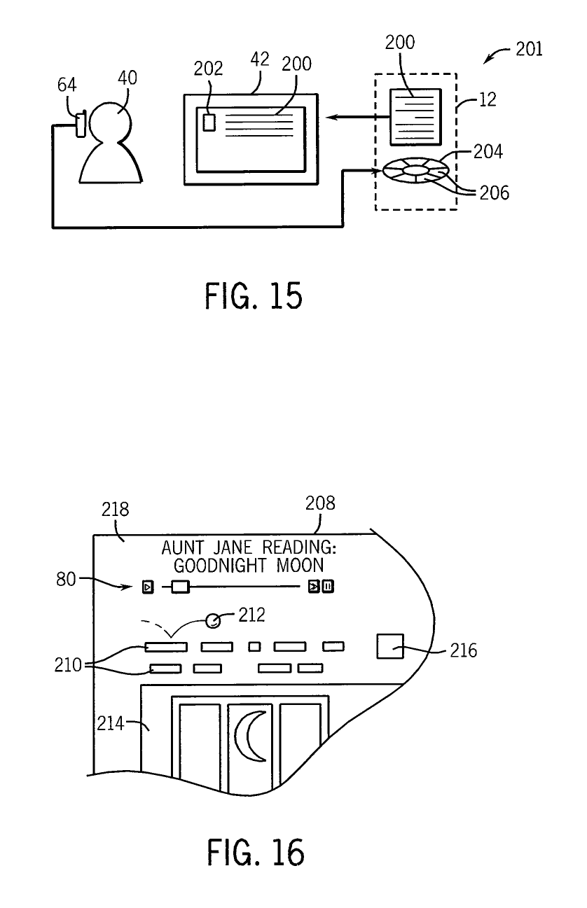

Referring now to FIGS. 15 and 16, it will be appreciated that this underlying technology may be used not simply for oral histories but for personalizing other recorded information. For example, in a storytelling system 201, a user 40, for example a relative of a child, may prepare an audio recording of a children's book, the user 40 making use of the telephone 64 or 66 and a terminal 42. In this process, user 40 may select a children's story 200, the text and graphics of which may be stored on the server 12 as a library of copyright cleared or licensed stories. By invoking a screen button 202 on a webpage generated by the server 12, similar to history button 174, a call may be made to the user 40 allowing them to read the text of the story displayed on the terminal 42 and record that reading in a linked audio file 204. The linked audio file 204 may have markers denoting segments 206 related to different passages of the text of the story 200, for example mapped to particular pages or illustrations of the story by speech recognition technology. Note that the speech recognition may be compliant to many different speakers because of the known pattern of the text of the story 200. In one embodiment, the recording may be conducted entirely over a telephone system in a “call and response” format where portions of the story is read to the listener who may then repeat the story in their own words. Alternatively, the speaker may annotate the recorded story with their own personal comments or tags.

The child may then listen to the recorded story as accessed through a playback screen 208 being a dynamically generated webpage from the server 12 providing for an audio widget 80 of the type described above allowing playing, pausing and rewinding of the audio files 204. Segmentation of the audio file 204 allows the playback screen 208 to display words 210 of the text of the story 200 together with a highlighting mechanism 212 (shown as a bouncing ball) synchronizing the spoken words of the audio file 204 to the displayed written words of the story.

A graphic display window 214 may provide for associated graphics associated with the story 200 (also synchronized to the spoken words of the audio file 204) including still and/or animated graphical images.

A next page button 216 may provide an alternate input to the audio widget 80 invoking a transition between segments of the audio file 204 to preserve time-honored tradition of the child pacing the telling of the story by turning the page. Title information 218 may be provided at the top of the playback screen 208, for example, recording the particular name of the relative reading the story and the selection being read which may also be used in an index of recorded information used to select the particular story to be read.

The present system further allows more innovative storytelling techniques including allowing different individuals to respond to the telling of the story by other individual sample by augmenting the story or by continuing the story in alternate fashion.

### V. Pharmaceutical Ordering System

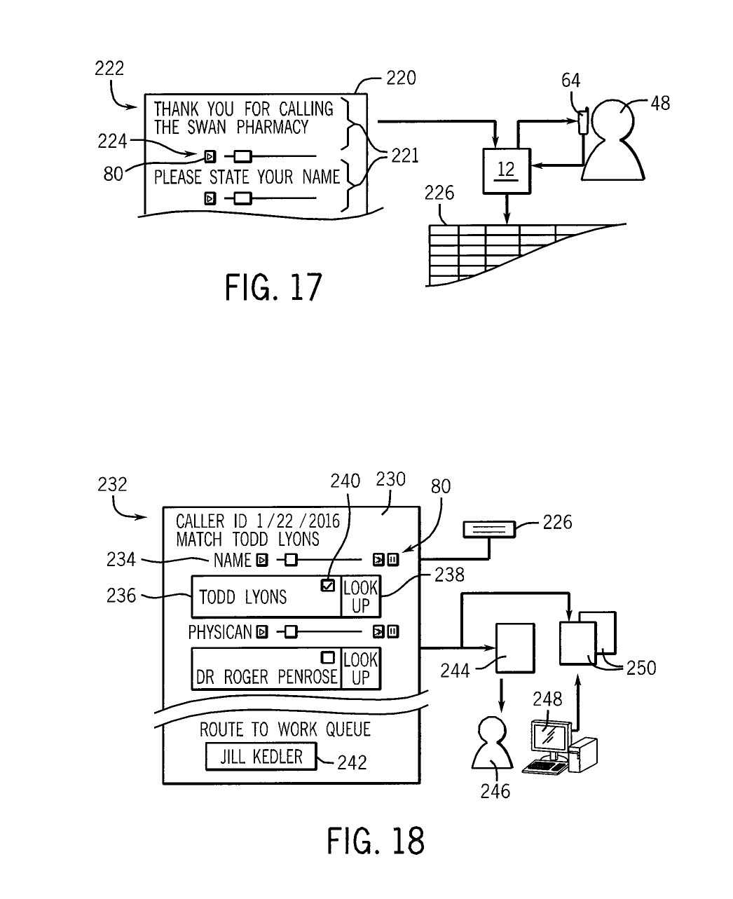

Referring now to FIGS. 17 and 18, the technology provided by the present invention can provide significant efficiencies in business processes where the workflows rely heavily on audio messages. In an example pharmacy system, an answering machine message may be prepared using the present invention through a message setup screen 220 implemented as a dynamic webpage generated by the server 12 executing the program 18. The message setup screen 220 allows a user to develop an interactive script of spoken instructions 221 for users calling in to the pharmacy telephone number. Each of the spoken instructions 221 may be associated with a text field 222 followed by an audio field 224 (depicted as an audio widget 80) used to capture a spoken recording of the text of the text field 222. This spoken recording may optionally be prepared automatically from the text field 222 by speech synthesis technology. Alternatively, the messages may be set up completely using the phone system in which case the audio field 224 may be used alone without the text field 222.

The audio field 224, input through the screen 220, may be employed by the server 12 so that a user 40 calling into the pharmacy number hears the set of instructions 221 and may respond to those instructions 221. The responses by the user 40 are recorded in a data file 226 together with other information about the call including time of day and telephone number of the caller user 40. The use of a text field 222 and audio field 224 for each instruction 221 allow the script to be used both for a telephonic call (using data of the audio field 224) and for the Internet or a webpage based messaging input system (using data of the text field 222).

At regular intervals, a workflow management screen 230 may be used to read the data file 226, for example, upon opening hours of the pharmacy and an individual may review the workflow management screen 230 to enroll the orders contained in the telephone calls into a workflow system.

The workflow management screen 230 may present for each call verification information 232, for example, the date and time of the call as previously recorded and any matching of the telephone number of the call with information already in the customer database used by the pharmacy.

Audio widgets 80 may be presented on the workflow management screen 230 providing access to each of the customer answers to the pre-prepared instructions 221 linked to those instructions which may be indicated by short notation 234. Thus, for example, the notation 234 of “name” may be indicated next to the audio widget 80 for the response of a customer to the instruction 221 that they provide his or her full name. The user of the workflow management screen 230 may then type the customer's name into a text box 236 associated with that instruction 221 or may use a lookup function invoked by buttons 238 to look up names pre-existing in the customer database.

Alternatively speech recognition technology may be used to pre-populate the text box 236 with a likely name employing knowledge of possible names from the customer database and the user of the workflow management screen 230 may simply verify the machine transcription, for example.

Similar steps may be performed with respect to the other instructions 221, for example, for instructions requiring identification of a physician, the particular prescription, medical insurance information, instructions related to the proper administration of the medicine by a patient, questions to the pharmacist concerning the proper dosage of and timing for taking the prescribed medicine, an indication of side effects and other matters pertinent to the safety of the prescribed medicine, as well as acknowledgment by the patient acknowledgements that he or she understands what has been transmitted during the session. The recordings can be preserved and stored into a patient account should there ever be a need to review the nature of the questions and answers . . . . The user of the workflow management screen 230 may then route this information now in machine-readable text and representing a customer order to a particular individual in the pharmacy using a routing entry box 242.

It will be appreciated that a similar set of operations may be performed using a standard telephone and employing the parallel audio file 224. In this case audio annotations may be added in the audio file 224 as it routed appropriately using for example spoken commands.

The necessary information is then forwarded to a workflow queue 244 to be processed by a pharmacist 246 using a terminal 248. Information about completion of the order may then be entered into the patient record database 250 recording prescription fulfillment and interfacing with billing systems as is generally understood in the art.

The system query and response features allow the pharmacist to provide information to the patient concerning dosage information and possible side effects or drug interaction information or other pertinent information and instructions as is now done at the time the patient retrieves her prescriptions. Each statement can be selected from a standard menu of comments and instructions previously recorded and ready for use to improve the efficiency of the pharmacy. Alternatively, a database may be pre-populated with a variety of statements and instructions and associated software used to select the specific combination pertinent to a particular drug and/or a particular patient. In either event, by using standard instructions and comments, each patient is given the same, pre-vetted information that has been determined to be both complete and accurate. Regardless of how the audio queries are set up, the patient is instructed to listen and respond after hearing each statement with an acknowledgement that she understands the particular instruction or statement. Should she not answer in the affirmative, the system of the present invention flags that response and alerts the pharmacist that further follow up is required before dispensing the drug. The system also preserves the full audio file for later retrieval should a question arise about the nature of the pharmacist's instructions and the patient's understanding of them.

Additionally, the system of the present invention may be used to manage incoming prescription requests received telephonically during the hours when the pharmacy is not staffed, such as overnight. The patient is provided with instructions to text (e.g., SMS) a specific message, such as the name of the pharmacy, to a short code (e.g., “12345”) identified with the pharmacy. This would initiate a call back from the system having a script of questions to be answered by the patient, such as the name of the prescribing physician, the name of the prescribed drug, and similar data required to fill the prescription. When the pharmacy staff returns to the pharmacy, they are presented with calls having a uniformly scripted set of answers that are more efficiently retrieved and navigated so that prescriptions can be filled or refilled more expediently, rather than being required to listen to several non-uniform voice mails presenting information in a jumbled set of conversations from which the pertinent information must be extracted. This also ensures that all required data is collected rather than learn after listening to an ad hoc voice mail that the patient failed to provide some key bit of information then requiring a call back to the patient and the possibility of a “phone tag” event which is not only a waste of time but prolongs the time of delivery of important medications.

### VI. Medical Triage

The system of the present invention is well adapted to aid professionals in high demand when regularly facing random events, and one such set of circumstances is regularly encountered in the medical profession (among others). For example, a doctor or a doctor's office routinely fields inbound telephone calls from patients or prospective patients experiencing some malady or another. An assistant pre-screens these calls, summarizes the patient's medical complaint and queues the doctor to take certain calls in a certain order. Currently, these calls are managed in real time and while the nurse or assistant is dealing with one patient another is either on hold or is asked to call back and try to have his call answered as and when the assistant or nurse has the time to attend to that patient's needs.

In most every case, the questions are from a standard set of queries intended to elicit some basic information before turning the patient over to the doctor. For example, the medical staff wants to know the identity of the caller and whether the caller is enquiring on his own behalf or that of another, a brief description of the problems and symptoms, how long they have persisted, whatever the patient has done to alleviate the problem and how well that may have worked, a description of the medications the patient is taking, the patient's temperature, and other manifestations of the problem prompting the call. Additionally, if the caller is experiencing an emergency, the caller can be instructed to call an emergency response line and the appropriate telephone numbers provided.

Using the system of the present invention, the doctor's office staff can pre-record the questions for which the doctor seeks basic information. In the query and response mode of the system, a question is posed and the patient given the opportunity to answer. If the patient needs to gather information, the call can be interrupted and resumed at a later time inasmuch as each call has a unique identifier. For example, the patient may need to gather medicines to respond to a question about those items; the patient may need to take his temperature or pulse rate. In these events, the caller can hang up and then later resume the call to complete the triage questions.

Once the call is completed, the nurse or other office professional can listen to the patient's responses, flag those of particular interest for the doctor and perhaps add notes of her own to the audio file to focus the doctor's attention so he need not pay attention to background important for billing but not important for diagnosis. Pertinent files can be attached or links provided to aid the doctor and thereby increase the efficiency of the medical review. The nurse may deem it important to call the patient back either to provide information or solicit more data sought by the doctor. Because there are no practical limits on how many inbound calls can be managed and due to the asynchronous nature of the conversation, the system maximizes the flow of information and patients always can “get through” to the medical staff without delays.

### VII. Electronic Voting System

The systems described in detail above can be adopted as a means for electronic voting in local or national elections, for referenda or other matters put to a group of voters who are authorized to participate in an election or referendum. Using such a system, voting becomes as convenient as access to one's telephone, although the system contemplates use as an adjunct to regular voting methods. In this embodiment, any time during a given voting period, an individual elector may phone a designated voting telephone number or log into a computer to initiate a phone call from a computer system to the elector. The alternatives for which votes are sought by an authorized elector may be presented to the elector by a prerecorded message in response to the telephone call and the elector may then respond and every response may be recorded and processed in the ways described above. Desirably, in the case of an election, the individual's choices may be recorded and stored in their own voice. An audio voting system of this type can provide significant advantages to the disabled community and those unfamiliar with written English.

Authentication of the authorized voter may be made using any of a number of biometric tools or devices. For example, when a voter registers a voice print may be recorded. Alternatively, many computers routinely incorporate biometric readers such as a fingerprint reader. As yet another alternative, the computer may have an auxiliary device that provides biometric identification. In these latter cases, authentication is performed at the computer which serves as a gateway to the initiation of a telephone call back to the user at a phone number that can also be authenticated to the user. Regardless of the manner in which the authorized voter is authenticated, (s) he may vote by responding to the ballot questions of candidates, propositions or other matters up for a vote via the system of the present invention.

The invention has now been described with reference to several alternative embodiments meant to illustrate the manner in which it can be implemented or adapted. There are many other applications in which the system of the present invention may be employed. In its most basic configuration, the system facilitates asynchronous conversations between or among individuals. A first person records one or more queries or prompts which may be in the form of open-ended or specific questions or prompts that are intended to cause or catalyze associated responses. The recorded materials may be supplemented with visual information as well, such as text or graphics or video. One or more responders can be directed to a website where they log on or register and provide a telephone number or like means for communicating with the system to provide their oral input. Regardless of the alternative route employed, the responders provide their oral (and optionally textual) responses which are captured and correlated with the associated question or prompt. The captured responses are then recorded for playback. During the playback phase, the listener is able to tag or flag portions of the audio file containing information warranting specific identification, for example a particularly significant response. The listener can also add textual flags or comments associated with a particular segment of the audio file. The flags and comments become a part of the audio history and are preserved along with it in the form of an annotated audio file that can be preserved either as the permanent file or as a second copy or version when it is desired to maintain the original audio file without alteration. Thereafter, a subsequent listener or evaluator may recall the annotated audio file and navigate to those portions of interest by using the metadata found in the flags, tags and notes added to the original audio recording. In this fashion, the evaluator may reduce the amount of time necessary to extract information of interest by navigating to specific timeframes within the entire file. This ability to navigate vastly improves the efficiency of search over other historical methods, largely based on linear search (listen to the entire file) or hunt-and-peck (guess where in the file information of interest may be found). In other instantiation of the system, the originator of the asynchronous conversation may “flag” segments of sufficient interest to return to them in the future, such as specific segments in an oral history or genealogical “conversation.” Certain flags can be auto-generated by the system, such as flags to separate and identify specific question and answer segments so a listener can isolate on them. Many other advantages of the present invention will become apparent to those skilled in the art as they implement it for their intended purposes based on the detailed descriptions set forth herein.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context. Likewise, the description of preferred embodiments sometimes refers to “telephone(s)” or “telephony” to illustrate certain aspects of the present invention. These terms should be interpreted as broadly as the prior art permits to include any device or software that provides the functionality of a telephone in permitting voice or voice-like transmission that can be spoken and/or heard or interpreted whether by means of the PSTN, POTS, RF or microwave transmission or an Internet enabled or assisted process such as Skype or its or their equivalents. In a similar vein, the specification refers from time to time to computers, electronic computers or computer server to complete the description; and these or similar terms should be interpreted as broadly as the prior art permits to include any combination of hardware and/or software having the functionality of memory (whether static or dynamic, volatile or non-volatile) and a processor, such as a microprocessor communicating with that memory, where such functionality may be local, distributed or remote (such as resident in the cloud).

Regardless of the specific application of the system of the present invention, when put to use over time, a considerable volume of data will be generated by users interacting with the system. That data can be mined or analyzed statistically to extract information and intelligence that in turn can be used as feedback to improve the efficacy of the system or to afford those in a position to undertake such analyses to function as infomediaries. Other comparable uses of data histories may likewise be envisaged by those skilled in the art.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

We claim:

1. A system for managing a conversation stream in which one or more conversation originators interact asynchronously with one or more conversation responders, wherein said system includes an electronic computer executing a stored program held in non-transient media and communicating electronically with a public switched telephone network and with the Internet, and further wherein the computer executes the stored program to:
(a) receive from an originator an initial audio file comprising a series of verbal prompts intended to elicit responses from a responder for storage in a memory accessible to the electronic computer;
(b) accept a contact from a responder accessing the computer via a webpage operatively associated with said stored program through the Internet to further:
(i) monitor a conversation stream comprising a sequence of said verbal prompts followed by audio responses to each prompt spoken by the responder;
(ii) record the conversation stream for later play-back;
(c) generate an interface accessible by a person with permission to listen to the conversation stream, allowing the listener to select among responder's responses and for each selected response, presenting the listener with the options to:
(i) add metadata flags to the conversation stream to identify at least one portion thereof and
(ii) to add notes which accompany the conversation stream to record listener comments, both of said flags and notes clocked to the conversation stream so they are associated with specific segments thereof;
(d) store a metadata tagged and commented conversation stream for subsequent retrieval as an integral file.

2. A system for conducting academic oral examinations comprising:
an electronic computer executing a stored program held in non-transient media and communicating electronically with a public switched telephone network and with the Internet, the electronic computer executing the stored program to:
(a) receive an identifier of at least one oral examination candidate;
(b) receive a set of oral examination questions from an academic agent;
(c) within a predetermined time period, establishing telephonic communication with the oral examination candidate and communicating the set of oral examination questions as audio signals over a telephone to the candidate while recording answers to those questions; and
(d) provide access to the recorded answers identified to the questions and to the oral examination candidate over the Internet to the academic agent.

3. The system of claim 2 further providing access over at least one of the telephone system and the Internet to the questions and answers by the oral examination candidate.

4. The system of claim 3 wherein the access includes a recorded answer to at least one question from another oral examination candidate judged to be a best answer.

5. The system of claim 2 further receiving over the Internet an input from the academic agent for a grading of the answers.

6. The system of claim 5 further providing access over the Internet to a history of grades of the oral examination candidate for previous oral examinations.

7. The system of claim 5 further receiving input over the Internet from the academic agent identifying a recorded answer for each question from another oral examination candidate judged to be a best answer.

8. The system of claim 2 further providing access over the Internet to the academic agent of statistics of other oral examination candidates receiving the oral examination questions.

9. The system of claim 2 receiving input from the academic agent over the Internet of comments on the recorded answers to be stored linked to the recorded answers.

10. The system of claim 9 wherein the comments are selected from written comments and recorded comments.

11. The system of claim 2 wherein the electronic computer further executes the stored program to send an e-mail to the oral examination candidate indicating the predetermined time period.

12. The system of claim 2 wherein the electronic computer further executes the stored program to accept a telephone number identified to the oral examination candidate and wherein the telephonic conversation is established by an electronic computer calling the oral examination candidate on the telephone number.

13. The system of claim 2 wherein the electronic computer further executes the stored program to randomly select among oral examination questions to be communicated to the oral examination candidate during the telephonic communication.

14. The system of claim 2 wherein the electronic computer further executes the stored program to forward at least a subset of the oral examination questions and recorded responses to a second academic agent for review.

15. The system of claim 14 wherein the electronic computer further executes the stored program to provide a grade to the oral examination candidate being a combination of grades by the academic agent and the second academic agent.

16. A system for audio communication between semi-anonymous dating individuals including a questioner and a responder, the system comprising:
an electronic computer executing a stored program held in non-transient media and communicating electronically with a public switched telephone network and with the Internet, the electronic computer executing the stored program to:
(a) record from the questioner at least one question identified to a responder;
(b) contact the identified responder to indicate pending questions and receive a response;
(c) establish a telephone connection to the responder based on the response, the telephone connection recording the responder's answers to the questions; and
(d) present the answers to the questioner by an audio playback mechanism.

17. The system for audio communication of claim 16 wherein the questions are provided to the responder contemporaneous with the recording of the responder's answers.

18. The system for audio communication of claim 16 wherein the questions are provided by an audio message over the telephone.

19. The system for audio communication of claim 16 wherein contacting the responder is via at least one of a telephone call, an e-mail, or a text message.

20. The system for audio communication of claim 16 wherein the electronic computer further provides before (a) a transmission of the message from the responder to the questioner indicating an interest in communication and providing identification so that the electronic computer may anonymously contact the responder with questions.

21. The system for audio communication of claim 16 wherein the electronic computer further provides a social networking engine allowing semi-anonymous identification of individuals according to information on the social networking engine and wherein the social networking engine presents webpages allowing indication of an interest in communication to be communicated between individuals using the social networking engine on a semi-anonymous basis.

22. The system for audio communication of claim 16 wherein step (a) provides the questioner with example questions.

23. The system for audio communication of claim 16 wherein the playback mechanism is an audio widget presented on a webpage.

24. A genealogical website system providing an electronic computer executing a stored program held in non-transient media and communicating electronically with a public switched telephone network and with the Internet, the electronic computer executing the stored program to:
(a) receive over the Internet information related to genealogical relationships between individuals having a permission set for the addition of genealogical information;
(b) establish telephonic communication with a first individual within the permission set to receive a spoken story related to at least one individual of the genealogical relationships;
(c) receive over the Internet from the first individual within the permission set an identification of the spoken story to the individual of the genealogical relationships; and
(d) provide a display via the Internet indicating the genealogical relationships between individuals having display features indicating spoken stories about the individual of the genealogical relationships accessible by commands via the Internet.

25. The genealogical website system of claim 24 wherein the spoken story is in response to at least one of a question or prompt by a second individual within the permission set.

26. The genealogical website system of claim 24 wherein the display is a genealogical tree display.

27. The genealogical website system of claim 24 wherein the first individual within the permission set is within the genealogical relationship between individuals and wherein the spoken story relates to the second individual within the permission set.

28. The genealogical website system of claim 24 wherein the spoken story is also identified to the first individual.

29. The genealogical website system of claim 24 wherein step (c) may identify multiple individuals to whom the spoken story relates.

30. The genealogical website system of claim 24 further including the step of allowing other individuals within the permission set to make additional modifications of the spoken story.

31. A storytelling website system providing an electronic computer executing a stored program held in non-transient media and communicating electronically with a public switched telephone network and with the Internet, the electronic computer executing the stored program to:
(a) receive from a storyteller an identification of a story to be told as selected from a set of stories held in the non-transient media in text files;
(b) record the storyteller's voice reading the text file of the selected story synchronized to the text file;
(c) receive from a listener identification of the story to be told as selected from a set of stories having recorded storyteller voices; and
(d) in response to the identification from the listener, play the recording of the identified storyteller's voice.

32. The storytelling website system of claim 31 wherein the recording of step (b) is performed over a telephone.

33. The storytelling website system of claim 31 wherein step (d) presents a webpage displaying text of the selected story synchronized to a playing back of the recording

34. A pharmacy call answering system comprising:
an electronic computer executing a stored program held in non-transient media and communicating electronically with a public switched telephone network and with the Internet, the electronic computer executing the stored program to:
(a) receive telephonic communications from individuals seeking prescriptions and using telephones associated with the individuals;
(b) provide a set of recorded questions to the individuals separated by periods during which the individuals may respond;
(c) record individual responses in the periods of separation;
(d) provide access to the recorded responses associated with the questions over the Internet for transcription of the recorded responses and linkage of the responses to a patient file; and
(e) enroll a prescription request associated with the telephonic communication in a work queue accessible by pharmacy workers over a computer terminal.

35. The pharmacy call answering system of claim 34 wherein the questions are selected from the group consisting of: a name of a referring physician, a patient name, and a medical insurance identification.

36. The pharmacy call answering system of claim 34 wherein the transcription provides a lookup table of existing patient names for matching to the patient name.

37. The pharmacy call answering system of claim 34 wherein the transcription provides proposed transcriptions based on the patient name from the table of patient data.

38. The pharmacy call answering system of claim 34 wherein the prescription request is further enrolled within a file associated with the patient.

39. The pharmacy call answering system of claim 34 wherein the patient name is pre-populated based on a telephone number of the patient.
